(19) United States
(12) Patent Application Publication
(10) Pub. No.: US 2026/0114684 A1
(43) Pub. Date: Apr. 30, 2026

(54) VACUUM CLEANER

(71) Applicant: SAMSUNG ELECTRONICS CO., LTD., Suwon-si (KR)

(72) Inventors: Jeongwang CHO, Suwon-si (KR); Hyunju LEE, Suwon-si (KR); Dongjin CHO, Suwon-si (KR); Youngjun CHO, Suwon-si (KR); Seungryong CHA, Suwon-si (KR); Ingyu CHOI, Suwon-si (KR); Junggyun HAN, Suwon-si (KR)

(73) Assignee: SAMSUNG ELECTRONICS CO., LTD., Suwon-si (KR)

(21) Appl. No.: 19/433,452

(22) Filed: Dec. 26, 2025

Related U.S. Application Data
(63) Continuation of application No. PCT/KR2024/006310, filed on May 10, 2024.

(30) Foreign Application Priority Data
Jul. 14, 2023 (KR) 10-2023-0092013

(51) Int. Cl. A47L 9/00; A47L 7/00; A47L 9/02; F16C 33/34

(52) U.S. Cl. CPC A47L 9/009; A47L 7/0066; A47L 9/02; F16C 33/34

(57) ABSTRACT

A vacuum cleaner capable of preventing hair or foreign substance from accumulating by improving a structure of a roller mounted on an intake nozzle. The vacuum cleaner includes an intake nozzle, including an intake path, useable to clean a surface by an intake force, and a roller device, which is rotatable, to be arranged in the intake nozzle. The roller device includes a roller having a surface inclined at a first angle, and a rotation shaft configured to support the roller, the rotation shaft being at a second angle equal to the first angle at which the surface is inclined.

### CROSS-REFERENCE TO RELATED APPLICATION

This application is a continuation application, under 35 U.S.C. § 111(a), of international application No. PCT/KR2024/006310, filed May 10, 2024, which claims priority under 35 U. S. C. § 119 to Korean Patent Application No. 10-2023-0092013, filed Jul. 14, 2023, the disclosures of which are incorporated herein by reference in their entireties.

### TECHNICAL FIELD

The present disclosure relates to a vacuum cleaner, and more particularly, to a vacuum cleaner having an improved structure to prevent hair or foreign substances from getting caught in a roller.

### BACKGROUND ART

In general, a cleaner is a device that removes foreign substances (rubbish) and cleans a room, and vacuum cleaners are commonly used in homes. A vacuum cleaner cleans a room by drawing in air using an intake force of a fan motor unit and then separating foreign substances in the drawn air with devices such as filters.

Such a vacuum cleaner includes a canister type and upright type, and recently, a robot vacuum cleaner that performs cleaning tasks by traveling around a cleaning region on its own without user intervention and drawing in foreign substances such as dust from a surface to be cleaned has become popular.

A canister vacuum cleaner includes a main body in which a blower and a dust collector are installed, an intake nozzle installed separately from the main body to drawn in dust from a floor, and a connecting pipe connecting the main body and the intake nozzle.

Therefore, a user cleans by holding a handle installed on the connecting pipe and moving the intake nozzle in a direction of being cleaned.

An upright vacuum cleaner includes an upright main body and an intake nozzle integrally coupled to a lower portion of the main body. A user cleans by holding a handle provided on an upper side of the main body and moving the entire main body of the upright vacuum cleaner.

In an upright vacuum cleaner, a drum brush is mounted inside an intake nozzle to increase cleaning efficiency. The drum brush separates foreign substances stuck on a surface to be cleaned from the surface to be cleaned by rotating at high speed and coming into contact with the surface to be cleaned, and the separated foreign substances are drawn into the intake nozzle and then collected by a dust collector provided in a main body.

An intake nozzle of such a vacuum cleaner may be equipped with rollers to facilitate movement.

### DISCLOSURE

### Technical Problem

The present disclosure is directed to providing a vacuum cleaner capable of preventing hair or foreign substances from accumulating by improving a structure of a roller mounted on an intake nozzle.

The present disclosure is directed to providing a vacuum cleaner capable of facilitating discharge of foreign substances by improving a mounting structure of a roller.

The present disclosure is directed to providing a vacuum cleaner capable of facilitating attachment and detachment of a roller by improving a roller structure.

Technical tasks to be achieved in this document are not limited to the technical tasks mentioned above, and other technical tasks not mentioned will be clearly understood by those skilled in the art to which the present invention belongs from the description below.

### Technical Solution

A vacuum cleaner according to an embodiment of the present disclosure may include an intake nozzle, including an intake path, useable to clean a surface B by an intake force, and a roller device, which is rotatable, to be arranged in the intake nozzle, wherein the roller device may include a roller having an surface inclined at a first angle and a rotation shaft configured to support the roller, the rotation shaft being at a second angle equal to the first angle at which the surface is inclined.

A vacuum cleaner according to an embodiment of the present disclosure may include a cleaner body, and an intake nozzle, to be connected to the cleaner body, having an intake path, the intake nozzle, useable to clean a surface by an intake force, wherein the intake nozzle may include a roller installation part provided on a bottom surface of the intake nozzle, a rotation shaft installed on the roller installation part to be inclined with respect to the bottom surface, and a roller rotatably mounted on the rotation shaft and having an inclined surface of an inclined angle equal to an inclined angle of the rotation shaft.

### Advantageous Effects

According to an embodiment, a mounting structure of a roller can be improved to facilitate discharge of foreign substances.

According to an embodiment, a roller structure can be improved to facilitate attachment and detachment of a roller.

### DESCRIPTION OF DRAWINGS

FIG. 1 is a perspective view illustrating a vacuum cleaner according to an embodiment.

FIG. 2 is a perspective view illustrating an intake nozzle of the vacuum cleaner illustrated in FIG. 1 according to an embodiment.

FIG. 3 is a bottom view illustrating the intake nozzle illustrated in FIG. 2 according to an embodiment.

FIG. 4 is an enlarged view of area B in FIG. 3 illustrating a roller mounted on the intake nozzle according to an embodiment.

FIG. 5 is a partially exploded perspective view illustrating the roller mounted on the intake nozzle according to an embodiment.

FIG. 6 is a cross-sectional view of portion A-A′ in FIG. 2 illustrating the roller mounted on the intake nozzle according to an embodiment.

FIG. 7 is an enlarged cross-sectional view of area C in FIG. 6 illustrating the roller according to an embodiment.

FIG. 8 is a view illustrating a roller installation part of the intake nozzle and a bypass hole formed on the roller installation part according to an embodiment.

FIG. 9 is a view showing the flow of air passing through the bypass hole formed on the roller installation part of the intake nozzle according to an embodiment.

FIG. 10 is a view illustrating a bypass hole formed on a roller installation part of an intake nozzle according to an embodiment.

FIG. 11 is a view showing a flow of air passing through the bypass hole of the intake nozzle illustrated in FIG. 10 according to an embodiment.

FIG. 12 is a view illustrating a bypass hole formed on a roller installation part of an intake nozzle according to an embodiment.

FIG. 13 is a view showing a flow of air passing through the bypass hole of the intake nozzle illustrated in FIG. 12 according to an embodiment.

### MODE OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A and B,” “at least one of A or B,” “A, B or C,” “at least one of A, B and C,” and “at least one of A, B, or C” used herein may include any and all combinations of one or more of the associated listed items.

The expression of “and/or” includes a plurality of combinations of relevant items or any one item among a plurality of relevant items.

Herein, the expressions “a first,” “a second,” “the first,” “the second,” etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the expressions “including,” “having,” and the like are used to specify features, numbers, steps, operations, elements, components, or combinations thereof, but do not preclude the presence or addition of one or more of the features, elements, steps, operations, elements, components, or combinations thereof.

When an element refers to being “connected to,” “coupled to,” “supported on” or “contacted with” another element, this includes not only when elements are directly connected, coupled, supported or contacted, but also when elements are indirectly connected, coupled, supported or contacted through a third element.

Throughout the description, when an element is located “on” another element, this includes not only when the element is in contact with the other element, but also when there is another element between the two elements.

The expressions “front,” “rear,” “left,” and “right” used in the description below are defined based on the drawings, and the shape and position of each component are not limited by these expressions.

Hereinafter, embodiments of the present disclosure will be described in detail with reference to the accompanying drawings.

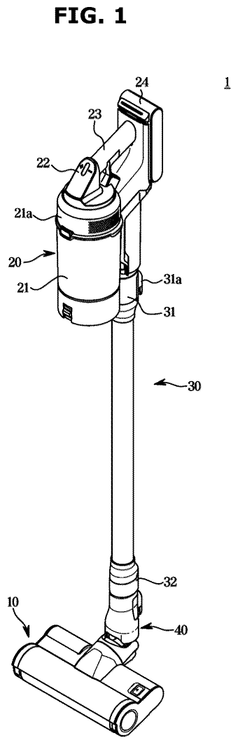

FIG. 1 is a perspective view illustrating a vacuum cleaner according to an embodiment.

As illustrated in FIG. 1, a vacuum cleaner 1 includes an intake nozzle 10 configured to draw in foreign substances from a surface to be cleaned (not shown, a floor B) by an air intake force, a cleaner body 20 configured such that foreign substances drawn through the intake nozzle 10 are collected therein, and a connecting member 30 configured to connect the intake nozzle 10 and the cleaner body 20.

The cleaner body 20 may include a motor (not shown) configured to generate an intake force necessary to draw in foreign substances from a surface to be cleaned, and a dust bin 21 in which foreign substances drawn from the surface to be cleaned are accommodated. The motor may generate power to generate the intake force inside the cleaner body 20. The dust bin 21 may be configured to be detachable from the cleaner body 20. The dust bin 21 may be configured to filter out and collect dust, dirt, etc., introduced through the intake nozzle 10.

The cleaner body 20 may include a filter housing 21a configured to accommodate a filter (not shown). The filter housing 21a may be formed in a substantially donut shape. There is no limitation on the type of filter, but a Hepa filter may be provided as an example. The filter is configured to filter ultrafine dust, etc., that is not filtered out in the dust bin 21.

The cleaner body 20 may include a handle 23 to enable a user to grip and manipulate the vacuum cleaner. The user may clean by holding the handle 23 and moving the intake nozzle 10 of the vacuum cleaner 1 in forward and backward directions.

The cleaner body 20 may further include a manipulating part 22. The user may turn the vacuum cleaner on/off or adjust intake strength, etc., by manipulating a power button, etc., provided on the manipulating part 22.

The cleaner body 20 may further include a battery 24. The battery 24 may be detachably mounted on the cleaner body 20. The battery 24 may be electrically connected to a charging terminal provided on a cleaner stand or docking station, although not shown. The battery 24 may be charged by receiving electrical power from the charging terminal provided on the vacuum cleaner stand or docking station.

The intake nozzle 10 may be configured to come into contact with a surface to be cleaned. The intake nozzle 10 may be configured to draw in foreign substances such as dust present on the surface to be cleaned by coming into contact with the surface to be cleaned. A detailed description of the intake nozzle 10 will be provided later.

The intake nozzle 10 and the cleaner body 20 may be connected by the connecting member 30. The connecting member 30 may be pivotally connected to the intake nozzle 10 at one end thereof so that the intake nozzle 10 may pivotally move with respect to the connecting member 30.

The connecting member 30 may include a first connecting part 31 and a second connecting part 32.

The first connecting part 31 is provided such that the connecting member 30 may be separated from or connected to the cleaner body 20. The first connecting part 31 may include a separation button 31a provided to separate from the cleaner body 20. After the connecting member 30 is separated from the cleaner body 20, the intake nozzle 10 may be directly connected to the cleaner body 20.

The second connecting part 32 is provided to allow the intake nozzle 10 to be separated therefrom or combined therewith. The second connecting part 32 is provided to be separable from the intake nozzle 10 or to be combinable with the intake nozzle 10.

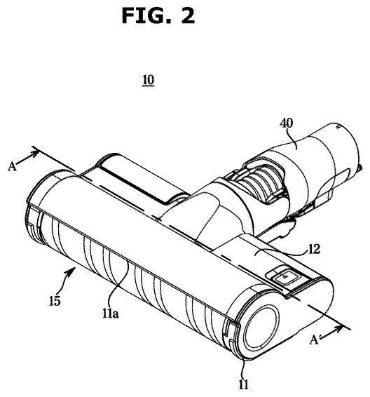

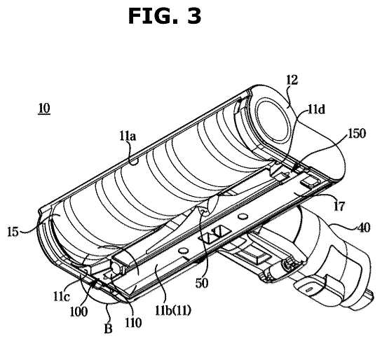

FIG. 2 is a perspective view illustrating an intake nozzle of the vacuum cleaner illustrated in FIG. 1, and FIG. 3 is a bottom view illustrating the intake nozzle illustrated in FIG. 2.

As illustrated in FIGS. 2 and 3, the intake nozzle 10 of the vacuum cleaner 1 may be connected to the connecting member 30 or the cleaner body 20 through a connecting bracket 40.

The intake nozzle 10 may be connected to the second connecting part 32 of the connecting member 30. The connecting bracket 40 of the intake nozzle 10 may be connected to the second connecting part 32 of the connecting member 30.

The connecting bracket 40 may be pivotally connected to the intake nozzle 10 so that the intake nozzle 10 may pivotally move relative to the connecting member 30.

The intake nozzle 10 may include a base 11 configured to form a bottom surface, and a cover 12 combined with the base 11 to form an intake path 50 for cleaning a surface to be cleaned by an intake force.

The intake nozzle 10 may include an intake port 11a. The intake nozzle 10 may be formed by the base 11 and the cover 12. The intake port 11a may be formed in at least a portion of the base 11. The intake port 11a may be formed in a front center of the base 11. It is appropriate for the intake port 11a to be formed at the front center of base 11. The intake port 11a may be formed in at least a portion of the cover 12. It is appropriate for the intake port 11a to be formed at a front center of cover 12.

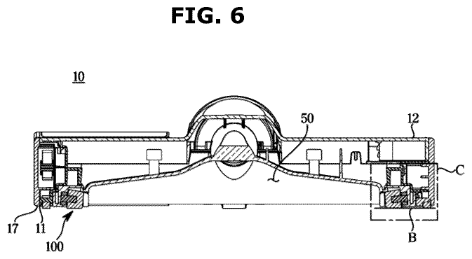

The intake port 11a may be formed by the combination of the base 11 and the cover 12. Air and foreign substances drawn from a surface B to be cleaned (see FIG. 6) through the intake port 11a may be collected by being delivered to the cleaner body 20 through the intake path 50.

The cover 12 is provided to form an upper outer appearance of the intake nozzle 10 by being coupled to an upper side of the base 11. The base 11 is provided to form a lower outer appearance of the intake nozzle 10 by being coupled to a lower side of the cover 12.

The cover 12 may be provided to form the intake path 50 therein by being combined with the base 11. The intake path 50 may be provided to be connected to the intake port 11a.

The intake nozzle 10 may include a drum brush 15. The drum brush 15 may be provided at the intake port 11a of the intake nozzle 10 to facilitate cleaning. The drum brush 15 may be provided on the intake path 50 of the intake nozzle 10. The drum brush 15 may be provided to be rotatable inside the intake nozzle 10. The drum brush 15 may be provided to be rotatable on the intake path 50 of the intake nozzle 10. The drum brush 15 may be provided to easily clean the floor or carpet, etc., by rotating inside the intake nozzle 10.

The intake nozzle 10 may include a roller device 100 provided to facilitate smooth movement. The roller device 100 may be provided on the base 11 to move the intake nozzle 10.

A roller installation part 150 may be provided on the base 11 of the intake nozzle 10 to allow the roller device 100 to be installed thereon. The roller installation part 150 may be provided in at least a portion of the base 11. The roller installation part 150 may be provided on an inner side of a bottom surface 17 of the base 11. A detailed description of the roller installation part 150 will be provided later.

The roller device 100 may be provided on the base 11 of the intake nozzle 10. The roller device 100 may be installed to be rotatable. This embodiment exemplifies, but is not limited to, the roller devices 100 being disposed on left and right sides of the base 11, respectively. For example, at least one roller device may be disposed depending on a shape or size of the intake nozzle.

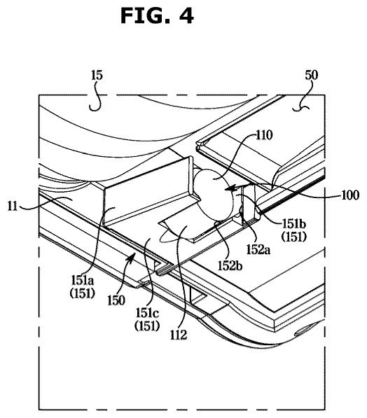

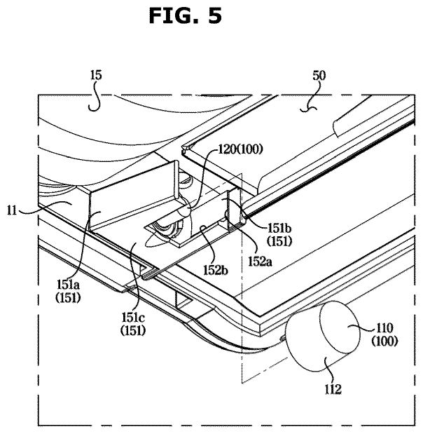

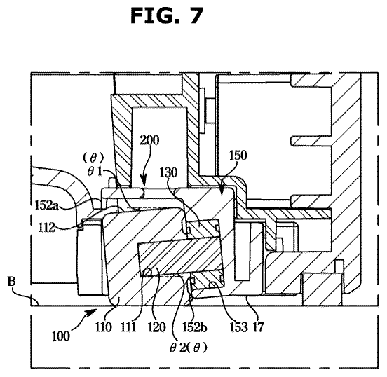

FIG. 4 is an enlarged view of area B in FIG. 3 illustrating a roller mounted on the intake nozzle according to an embodiment, FIG. 5 is a partially exploded perspective view illustrating the roller mounted on the intake nozzle according to an embodiment, FIG. 6 is a cross-sectional view of portion A-A′ in FIG. 2 illustrating the roller mounted on the intake nozzle, and FIG. 7 is an enlarged cross-sectional view of area C in FIG. 6 illustrating the roller according to an embodiment.

As illustrated in FIGS. 4 to 7, the roller device 100 provided to be rotatable in the intake nozzle 10 may include a roller 110 and a rotation shaft 120 configured to rotatably support the roller 110.

The roller device 100 may be provided on at least a portion of the base 11. The roller device 100 may be provided on the roller installation part 150 of the base 11. The roller installation part 150 may be provided on the bottom surface 17 of the base 11. The roller installation part 150 may be provided further inward than the bottom surface 17 of the base 11. The roller installation part 150 may be provided near the intake port 11a. The roller installation part 150 may be provided on the intake path 50 of the base 11. The roller installation part 150 may be disposed on the intake path 50 in which the drum brush 15 is installed.

The roller installation part 150 may be disposed on one side and the other side of the base 11. The roller installation part 150 may be provided on a portion of the base 11 forming the intake port 11a. The roller installation part 150 may be provided on each of left and right sides of the intake port 11a of the base 11. The roller installation part 150 may be provided on each of left and right side walls 11c and 11d forming the intake port 11a of the base 11.

The base 11 may include a base body 11b. The base body 11b may be provided to form the intake port 11a and the intake path 50. The base body 11b may include the left wall 11c and the right wall 11d. The left wall 11c and the right wall 11d of the base body 11b may be provided to form portions of the intake port 11a and the intake path 50. The intake path 50 may be provided inside the base body 11b. The connecting bracket 40 may be connected to a rear end of the base body 11b.

The roller installation part 150 may be provided on a portion of the base 11 forming the intake path 50. The roller installation part 150 may be provided on the left wall 11c and the right wall 11d of the base 11. The roller installation part 150 may be provided on the left wall 11c of the base 11 in a direction of directing to the intake port 11a. The roller installation part 150 may be provided on the right wall 11d of the base 11 in a direction of directing to the intake port 11a. The roller installation parts 150 provided on the left wall 11c and the right wall 11d of the base 11, respectively, may be provided to face each other toward a center of the base 11.

The roller installation part 150 may include a roller installation bracket 151. The roller installation bracket 151 may be provided to cover the roller 110. The roller installation bracket 151 may be provided to surround the outside of the roller 110. The roller installation bracket 151 may include a first bracket 151a provided to cover one side of the roller 110, a second bracket 151b corresponding to the first bracket 151a to cover the other side of the roller 110, and a third bracket 151c provided to connect the first bracket 151a and the second bracket 151b and corresponding to the surface B to be cleaned.

The first bracket 151a, the second bracket 151b, and the third bracket 151c of the roller installation bracket 151 may be provided in a plate shape to cover at least a portion of the roller 110. This embodiment exemplifies, but is not limited to, a roller installation bracket formed with a plate shape to cover the outside of a roller. For example, a roller installation bracket may be formed with a curved surface to surround the outside of a roller.

The roller device 100 may be mounted on the roller installation bracket 151. The roller device 100 may be rotatably mounted on the inside of the roller installation bracket 151.

The roller installation bracket 151 may be provided to allow the roller 110 of the roller device 100 to be mounted thereon or separated therefrom. The roller installation bracket 151 may include a first opening 152a to allow the roller 110 of the roller device 100 to be mounted thereon or separated therefrom. The first opening 152a may be formed to face the center of the base 11. The first opening 152a may be formed to face the intake path 50 of the base body 11b. The first opening 152a may be connected with the intake path 50.

A second opening 152b may be formed on the third bracket 151c of the roller installation bracket 151. The second opening 152b may be formed to face a lower side of the base 11. The second opening 152b may be formed to allow at least a portion of an inclined surface 112 of the roller 110, which will be described later, to come into contact with the surface B to be cleaned. The second opening 152b may be formed to be connected to the first opening 152a. The second opening 152b may be formed to be connected to a lower end of the first opening 152a.

The roller device 100 may include the roller 110 and the rotation shaft 120.

The roller 110 may have a coupling groove 111 formed at the center thereof to which the rotation shaft 120 is coupled. At least a portion of the rotation shaft 120 may be coupled to the coupling groove 111 of the roller 110. At least a portion of the rotation shaft 120 may be coupled to being press-fitted into the coupling groove 111 of the roller 110 and coupled thereto. The roller 110 may have a trapezoidal cross-section shape. The roller 110 may include the inclined surface 112 having a first angle θ1. The roller 110 may have an inclined angle θ of the first angle θ1. The inclined surface 112 of the roller 110 may be formed toward the center of the base 11. A cross-section of the roller 110 may have a trapezoidal shape with a width that becomes narrower toward the center of the base 11. At least a portion of the inclined surface 112 of the roller 110 may be provided to come into contact with the surface B to be cleaned. The first angle θ1 of the roller 110 may be formed as an acute angle. The inclined surface 112 of the roller 110 causes foreign substances such as hair, which are introduced into the roller 110 or the rotation shaft 120, to move to the intake path 50 side along the inclined surface of the first angle θ1 and be drawn in by the intake force.

Because the inclined surface 112 of the roller 110 is formed to be inclined to the center of the base 11, i.e., to the intake path 50 side, hair or foreign substances introduced through the first opening 152a and the second opening 152b of the roller installation bracket 151 may be guided to move directly along the inclined surface 112 to the intake path 50 side without staying on the roller 110 or the rotation shaft 120.

The roller 110 may be mounted on or separated from the rotation shaft 120 through the first opening 152a of the roller installation bracket 151. The first opening 152a of the roller installation bracket 151 is formed to the intake path 50 side of the base 11, so that hair or foreign substances moving along the inclined surface 112 of the roller 110 may be introduced into the intake path 50.

The rotation shaft 120 may be provided to be inclined with respect to the bottom surface 17 of the intake nozzle 10, i.e., the bottom surface 17 of the base 11. The rotation shaft 120 may be formed in a cylindrical shape. One end of the rotation shaft 120 may be provided on a roller installation bracket 151.

The rotation shaft 120 may be provided to be inclined at a second angle θ2. The rotation shaft 120 may have the inclined angle θ of the second angle θ2. The second angle θ2 of the rotation shaft 120 may be formed as an acute angle. The second angle θ2 of the rotation shaft 120 may be equal to the first angle θ1. The rotation shaft 120 may be provided to be inclined at the second angle θ2 that is equal to the first angle θ1 of the roller 110. The inclined surface 112 of the roller 110 may be provided to be parallel to the second angle θ2 of the rotation shaft 120.

The roller device 100 may include a bearing 130 provided to rotatably support the rotation shaft 120. The bearing 130 may rotatably support the rotation shaft 120 by being provided between the rotation shaft 120 and the roller installation bracket 151.

The roller installation bracket 151 may include a rotation shaft coupling groove 153 to allow the bearing 130 and the rotation shaft 120 to be coupled thereto. The rotation shaft coupling groove 153 may be provided on the inside of the roller installation bracket 151. The rotation shaft coupling groove 153 may be formed to be inclined at the second angle θ2 on an inner surface of the roller installation bracket 151. The rotation shaft coupling groove 153 may be provided to support the base 11 at the second angle θ2 so that the rotation shaft 120 may be provided to be inclined from the bottom surface 17 of the base 11 at the second angle θ2.

The rotation shaft 120 and the roller 110 may be coupled slantly at the second angle θ2 to the roller installation bracket 151. The roller 110 is slantly installed at the second angle θ2 on the base 11, so that the inclined surface 112 at the first angle θ1 comes into contact with the surface B to be cleaned and rotates. The inclined surface 112 of the roller 110 comes into contact with the surface B to be cleaned and rotates so that the intake nozzle 10 may move stably.

Because foreign substances such as hair on the surface B to be cleaned move toward the center of the base 11, i.e., to the intake path 50 side through the inclined surface 112 of the roller 110, foreign substances may be prevented from accumulating in the roller device 100.

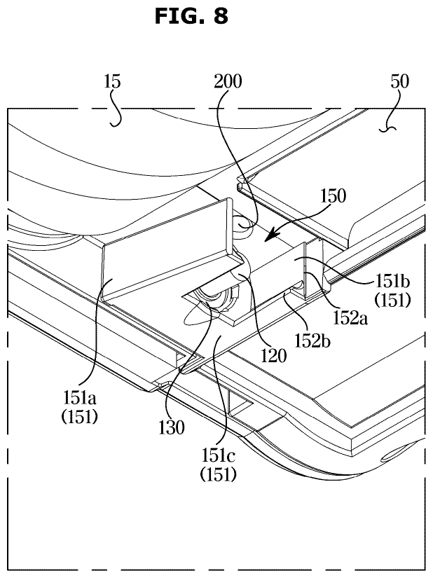

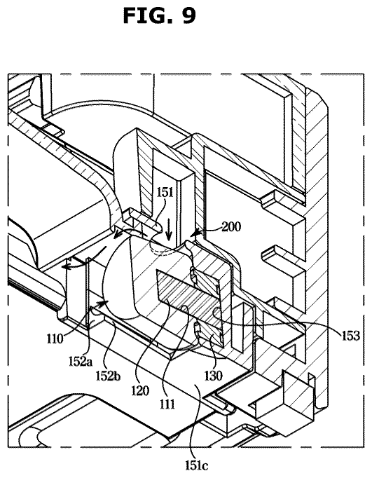

FIG. 8 is a view illustrating a roller installation part of the intake nozzle and a bypass hole formed on the roller installation part according to an embodiment, and FIG. 9 is a view showing the flow of air passing through the bypass hole formed on the roller installation part of the intake nozzle according to an embodiment. In the following, descriptions of configurations that overlap with the above descriptions will be omitted.

As illustrated in FIGS. 8 and 9, the roller installation part 150 of the intake nozzle 10 may include a bypass hole 200. The roller installation part 150 may include the bypass hole 200 provided to suppress eddies around the roller 110 and stabilize an airflow. The bypass hole 200 may be formed to allow air to be introduced into the roller installation part 150 side.

The bypass hole 200 is provided to allow air to be introduced into the roller installation part 150 side. Air introduced through the bypass hole 200 causes foreign substances including hair, etc., to move from the roller 110 to the intake path 50 side.

The bypass hole 200 may be provided on the roller installation part 150. The bypass hole 200 may be formed in at least a portion of the roller installation bracket 151. The bypass hole 200 may be formed opposite the first opening 152a of the roller installation bracket 151. The bypass hole 200 may be formed opposite the second opening 152b of the roller installation bracket 151. Air introduced into the intake nozzle 10 may be discharged through the bypass hole 200 formed opposite the second opening 152b of the roller installation bracket 151. This may be caused by a pressure difference with respect to the intake path 50 in the intake nozzle 10. Specifically, an area around the intake path 50 of the intake nozzle 10 is at a low pressure due to an intake force caused by the cleaner body 20, and opposite ends of the base 11 where the roller device 100 of the intake nozzle 10 is located are at a relatively high pressure. The bypass hole 200 formed on the roller installation part 150 on which the roller device 100 is installed is located in a high pressure area. Therefore, air is discharged through the bypass hole 200 in the high pressure area, and the air discharged through the bypass hole 200 moves foreign substances including hair on the roller 110 to the low pressure side, i.e., the intake path 50 side.

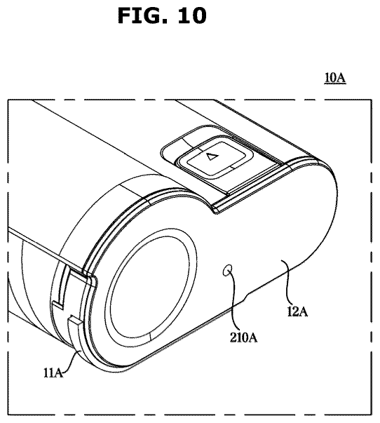

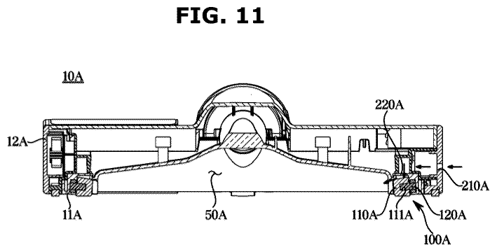

FIG. 10 is a view illustrating a bypass hole formed on a roller installation part of an intake nozzle according to an embodiment, and FIG. 11 is a view showing a flow of air passing through the bypass hole of the intake nozzle illustrated in FIG. 10. In the following, descriptions of configurations that overlap with the above descriptions will be omitted.

As illustrated in FIGS. 10 and 11, an intake nozzle 10A may include a bypass hole 200A provided to suppress eddies around a roller device 100A and stabilize an airflow.

The bypass hole 200A may be formed to allow air to be introduced into a roller installation part 150A side. The bypass hole 200A may be formed to allow air to be introduced into the roller installation part 150A side in which the roller device 100A is installed.

The bypass hole 200A may include a first bypass hole 210A formed on a cover 12A of the intake nozzle 10A, and a second bypass hole 220A formed on the roller installation part 150A.

The first bypass hole 210A may be formed in at least a portion of the cover 12A of the intake nozzle 10A. The first bypass hole 210A may be formed on the cover 12A at a position of being connected to the roller installation part 150A provided on the base 11A.

The second bypass hole 220A may be provided on the roller installation part 150A. The second bypass hole 220A may be formed in at least a portion of the roller installation bracket 151a. The second bypass hole 220A may be formed on an upper portion of the roller installation bracket 151a.

The first bypass hole 210A and the second bypass hole 220A may be connected to each other. Outside air introduced into the intake nozzle 10A through the first bypass hole 210A may be discharged through the second bypass hole 220A.

The air discharged through the second bypass hole 220A moves hair or foreign substances wound around a roller 110A to the low pressure side, i.e., an intake path 50A side.

The air introduced into the intake nozzle 10A through the first bypass hole 210A is discharged through the second bypass hole 220A, thereby allowing hair or foreign substances to be discharged from the roller 110A or a rotation shaft 120A mounted on the roller installation part 150A and moved to the intake path 50A side. The roller 110A may have a coupling groove 111A formed at the center thereof to which the rotation shaft 120A is coupled.

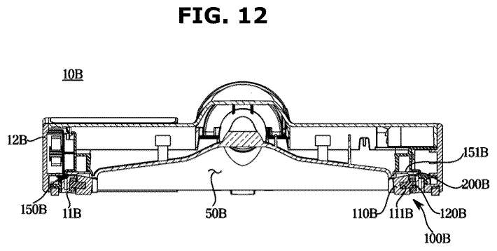

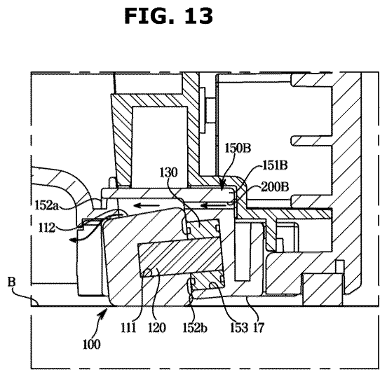

FIG. 12 is a view illustrating a bypass hole formed on a roller installation part of an intake nozzle according to an embodiment, and FIG. 13 is a view showing a flow of air passing through the bypass hole of the intake nozzle illustrated in FIG. 12. In the following, descriptions of configurations that overlap with the above descriptions will be omitted.

As illustrated in FIGS. 12 and 13, an intake nozzle 10B may include a bypass hole 200B provided to suppress eddies around a roller device 100B and stabilize an airflow. The roller 110B may have a coupling groove 111B formed at the center thereof to which the rotation shaft 120B is coupled.

The bypass hole 200B may be formed to allow air to be introduced into a roller installation part 150B side. The bypass hole 200B may be formed to allow air to be introduced into the roller installation part 150B side in which the roller device 100B is installed. The intake nozzle 10B may include a cover 12B.

The bypass hole 200B may be provided in the roller installation part 150B. The roller installation part 150B may include a roller installation bracket 151b configured to surround the roller 110B. The bypass hole 200B may be formed in at least a portion of the roller installation bracket 151b. The bypass hole 200B may be formed on a rear surface of the roller installation bracket 151a.

The bypass hole 200B may be formed from the rear to the front of the roller installation bracket 151b. The bypass hole 200B may be formed at a position of facing the first opening 152a of the roller installation bracket 151b. The air discharged through the bypass hole 200B causes hair or foreign substances to move to the intake path 50B along an inclined surface of the roller 110B without accumulating on the roller device 100B, which is rotatably mounted on the roller installation bracket 151b.

Hair wound around the roller 110B or foreign substances accumulated on the rotation shaft 120B may be moved to the intake path 50B by the air discharged through the bypass hole 200B.

A vacuum cleaner according to an embodiment may include an intake nozzle having an intake path for cleaning a surface B to be cleaned by an intake force, and a roller device rotatably provided in the intake nozzle, and the roller device may include a roller having an inclined surface and a rotation shaft configured to rotatably support the roller, the rotation shaft being formed at a second angle equal to a first angle of the inclined surface.

According to the present disclosure, the roller structure mounted on the intake nozzle can be improved to prevent hair or foreign substances from accumulating.

According to the present disclosure, the mounting structure of the roller can be improved to facilitate discharge of foreign substances.

According to the present disclosure, the roller structure can be improved to facilitate attachment and detachment of the roller.

The first angle θ1 or the second angle θ2 may be formed as an acute angle. The inclined surface 112 may be disposed parallel to the rotation shaft 120.

The intake nozzle 10 may include a base 11 on which an intake port 11a is formed, and a cover 12 combined with the base 11 to form an intake path 50 therein, and the base 11 may include a roller installation part 150 in which the roller device 100 is installed. The rotation shaft 120 may be disposed to face a center of the base 11.

The roller installation part 150 may include a roller installation bracket 151 formed to cover the roller 110, and the roller installation bracket 151 may include a first opening 152a formed to allow the roller to be coupled thereto or separated therefrom, and a second opening 152b formed to allow at least a portion of the inclined surface 112 of the roller 110 to come into contact with the surface B to be cleaned.

The first opening 152a may be formed to face the center of the base 11, and the second opening 152b may be formed to face a lower side of the base 11.

According to the present disclosure, the roller mounting structure can be improved to prevent hair or foreign substances from accumulating on the roller or the roller installation part.

The roller device 100 may include a bearing 130 provided to rotatably support the rotation shaft 120.

The first opening 152a may be connected with the intake path 50. The roller installation part 150 may include a bypass hole 200 formed by at least a portion being open. The bypass hole 200 may be disposed opposite the first opening 152a. The bypass hole 200 may be disposed opposite the second opening 152b. The bypass hole 200 may be formed as at least one.

According to the present disclosure, the roller mounting structure can be improved to facilitate discharge of hair or foreign substances.

A cross-section of the roller 110 may have a trapezoidal shape of becoming narrower toward the center of the base 11. According to the present disclosure, hair or foreign substances can move to the intake path side along the inclined surface of the roller, thereby facilitating discharge of the hair or foreign substances.

A vacuum cleaner according to an embodiment may include a cleaner body 20, and an intake nozzle 10 connected to the cleaner body 20 and having an intake path 50 for cleaning a surface B to be cleaned by an intake force, and the intake nozzle 10 may include a roller installation part 150 provided on a bottom surface 17 of the intake nozzle 10, a rotation shaft 120 installed on the roller installation part 150 to be inclined with respect to the bottom surface 17, and a roller 110 rotatably mounted on the rotation shaft 120 and having an inclined surface 112 of an inclined angle θ equal to an inclined angle θ of the rotation shaft 120.

According to the present disclosure, the roller structure mounted on the intake nozzle can be improved to prevent hair or foreign substances from accumulating and facilitate discharge of foreign substances.

According to the present disclosure, the roller structure can be improved to facilitate attachment and detachment of the roller.

The inclined angle θ may be formed as an acute angle.

The intake nozzle 10 may include a base 11 on which an intake port 11a is formed, and a cover 12 combined with the base 11 such that the intake path 50 is formed therein, and the roller installation part 150 may be provided on the base 11. The rotation shaft 120 may be disposed to face a center of the base 11.

The roller installation part 150 may include a first opening 152a formed in a center direction of the base 11 to allow the roller 110 to be coupled thereto or separated therefrom, and a second opening 152b formed in a lower direction of the base 11 so that at least a part of the roller 110 comes into contact with the surface B to be cleaned. The roller installation part 150 may include a bypass hole 200 formed by at least a portion being open.

Such the vacuum cleaner can improve the roller structure mounted on the intake nozzle to prevent hair or foreign substances from accumulating.

Effects according to the present disclosure are not limited to the effects mentioned above, and other effects not mentioned will be clearly understood by those skilled in the art to which the present disclosure belongs from the fallowing description.

In describing a vacuum cleaner with reference to the attached drawings above, specific shapes and directions have been mainly described, but it should be understood that various modifications and changes may be made by a person skilled in the art, and such modifications and changes should be interpreted as being included within the scope of the disclosed invention.

1. A vacuum cleaner comprising:
an intake nozzle, including an intake path. useable to clean a surface by an intake force; and
a roller device, which is rotatable, to be arranged in the intake nozzle,
wherein the roller device comprises:
a roller having a surface inclined at a first angle, and
a rotation shaft configured to support the roller, the rotation shaft being at a second angle equal to the first angle at which the surface is inclined.

2. The vacuum cleaner according to claim 1, wherein
the first angle or the second angle is formed as an acute angle.

3. The vacuum cleaner according to claim 1, wherein
the surface of the roller is parallel to the rotation shaft.

4. The vacuum cleaner according to claim 1, wherein
the intake nozzle comprises a base on which an intake port is formed, and a cover combined with the base to form at least a part of the intake path therein, and
the base comprises a roller installation part in which the roller device is installed.

5. The vacuum cleaner according to claim 4, wherein
the rotation shaft is disposed to face a center of the base.

6. The vacuum cleaner according to claim 4, wherein
the roller installation part comprises a roller installation bracket formed to cover the roller, and
the roller installation bracket comprises a first opening formed to allow the roller to be coupled thereto or separated therefrom, and a second opening formed to allow at least a portion of the surface of the roller to come into contact with the surface to be cleaned.

7. The vacuum cleaner according to claim 6, wherein
the first opening is formed to face a center of the base, and the second opening is formed to face a lower side of the base.

8. The vacuum cleaner according to claim 6, wherein
the roller device comprises a bearing provided to rotatably support the rotation shaft.

9. The vacuum cleaner according to claim 6, wherein
the first opening allows passage to the intake path.

10. The vacuum cleaner according to claim 6, wherein
the roller installation part comprises a bypass hole formed by at least a portion being open.

11. The vacuum cleaner according to claim 10, wherein
the bypass hole is opposite the first opening.

12. The vacuum cleaner according to claim 10, wherein
the bypass hole is opposite the second opening.

13. The vacuum cleaner according to claim 10, wherein
the bypass hole is formed as at least one.

14. The vacuum cleaner according to claim 1, wherein
a cross-section of the roller has a trapezoidal shape of is narrower toward a center of a base of the intake nozzle.
